(19) United States
(12) Patent Application Publication
(10) Pub. No.: US 2020/0142242 A1
(43) Pub. Date: May 7, 2020

(54) DISPLAY DEVICE

(71) Applicant: SHARP KABUSHIKI KAISHA, Sakai City, Osak (JP)

(72) Inventors: KATSUTOSHI KIKUCHI, Sakai City, Osaka (JP); MASAYUKI OHHASHI, Sakai City, Osaka (JP)

(21) Appl. No.: 16/616,471

(22) PCT Filed: May 18, 2018
(86) PCT No.: PCT/JP2018/019290

§ 371 Date: Nov. 24, 2019

(30) Foreign Application Priority Data
May 25, 2017 (JP) 2017-103626

(51) Int. Cl. G02F 1/1333; G02F 1/1335; F21V 8/00

(52) U.S. Cl. CPC G02F 1/133308; G02F 1/133528; G02F 2001/133314; G02F 2201/56; G02B 6/0088

(57) ABSTRACT

A display device includes: a display panel that has a panel through hole penetrating in a thickness direction and displays an image; a light source that emits light for display on the display panel; and a housing that accommodates the light source and has a housing through hole penetrating the housing, communicating with the panel through hole, and smaller than the panel through hole.

### TECHNICAL FIELD

The present invention relates to a display device.

### BACKGROUND ART

As an example of a conventional liquid crystal display device, the one described in Patent Document 1 below is known. The liquid crystal display device described in Patent Document 1 has a backlight device that includes: an LED; a sheet-shaped optical member provided for exerting an optical action on light from the LED, and having a through hole penetrating in a thickness direction; and a regulating part that has a communicating hole that communicates with the through hole and is inserted into the through hole to be brought into contact with the inner surface of the through hole, to thereby regulate the displacement of the optical member in a direction along its plate surface.

### RELATED ART DOCUMENT

### Patent Document

Patent Document 1: WO 2015/178299

### Problem to be Solved by the Invention

In the liquid crystal display device described in Patent Document 1 listed above, a liquid crystal panel is provided with a panel side through hole communicating with the through hole in the backlight device, and a cap member that is passed through the through hole and the panel side through hole. When an external object is put into the through hole and the panel side through hole, the cap member can protect the edge of the panel side through hole in the liquid crystal panel. However, the cap member is provided with a hook-like pressing part, and thus the area where an image cannot be displayed tends to be wide in the vicinity of the panel side through hole.

### DISCLOSURE OF THE PRESENT INVENTION

The present invention has been completed in view of the above circumstances, and an object thereof is to widen the area where an image can be displayed.

### Means for Solving the Problem

The display device of the present invention includes: a display panel that has a panel through hole penetrating in a thickness direction and displays an image; a light source that emits light for display on the display panel; and a housing that accommodates the light source and has a housing through hole penetrating the housing, communicating with the panel through hole, and smaller than the panel through hole.

With this configuration, an image is displayed on the display panel by using the light emitted from the light source. The panel through hole that penetrates the display panel along the thickness direction is arranged in such a manner as to communicate with the housing through hole that penetrates the housing accommodating the light source. Accordingly, an external object can be put into these panel through hole and housing through hole. Since the housing through hole is smaller than the panel through hole, when an external object is put into the panel through hole and the housing through hole as described above, the object is likely to interfere with an edge of the relatively small housing through hole and is less likely to interfere with an edge of the relatively large panel through hole. Therefore, the edge of the panel through hole in the display panel generally lower in mechanical strength than the housing is unlikely to suffer from damage or the like. In particular, this is suitable to, for example, a case of putting an object for positioning the display device in the panel through hole and the housing through hole. This eliminates the need for a cap member as in the prior art, so that the portion around the panel through hole where no image can be displayed becomes narrow, thereby widening an area in which an image can be displayed.

Furthermore, even if there is generated a portion where light from the light source cannot be applied toward the display panel near the housing through hole, the housing through hole is made smaller than the panel through hole so that the portion where the light cannot be applied near the housing through hole is unlikely to overlap the portion where an image can be displayed in the display panel. As a result, display unevenness hardly occurs on the display panel, and the display quality is hardly deteriorated.

### Advantageous Effect of Invention

According to the present invention, it is possible to increase the area in which an image can be displayed.

### BRIEF DESCRIPTION OF THE DRAWINGS

FIG. 1 is a plan view of a liquid crystal panel provided in a liquid crystal display device according to a first embodiment of the present invention.

FIG. 2 is a cross-sectional view of the liquid crystal display device taken along line A-A in FIG. 1.

FIG. 3 is an enlarged plan view of a panel through hole and its vicinity in the liquid crystal panel.

FIG. 4 is a cross-sectional view of a liquid crystal display device according to a second embodiment of the present invention.

FIG. 5 is an enlarged plan view of a panel through hole and its vicinity in a liquid crystal panel included in a liquid crystal display device according to a third embodiment of the present invention.

### MODES FOR CARRYING OUT THE INVENTION

### First Embodiment

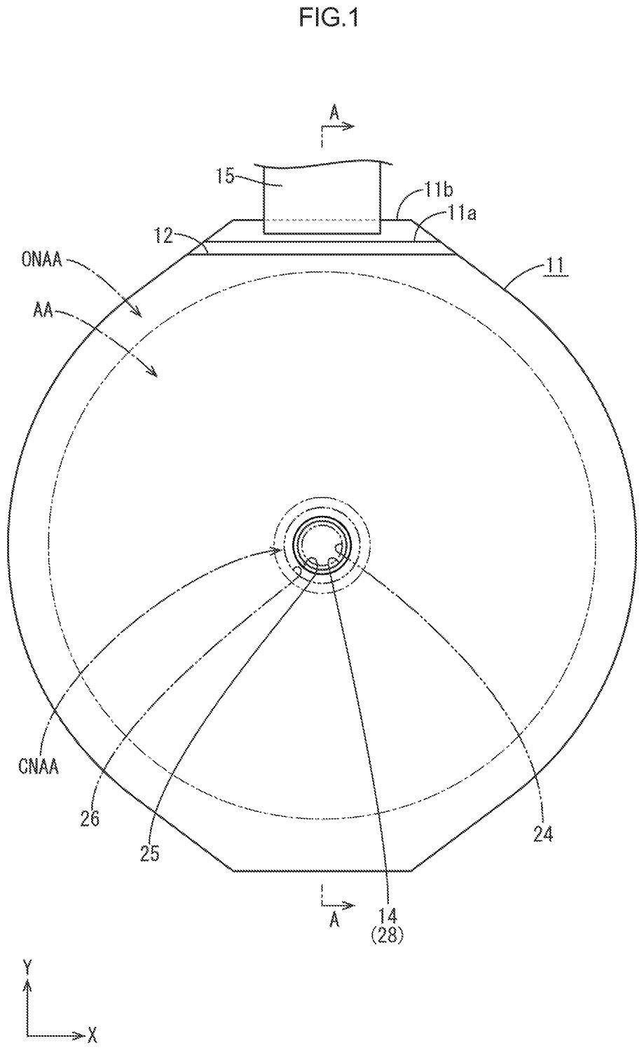

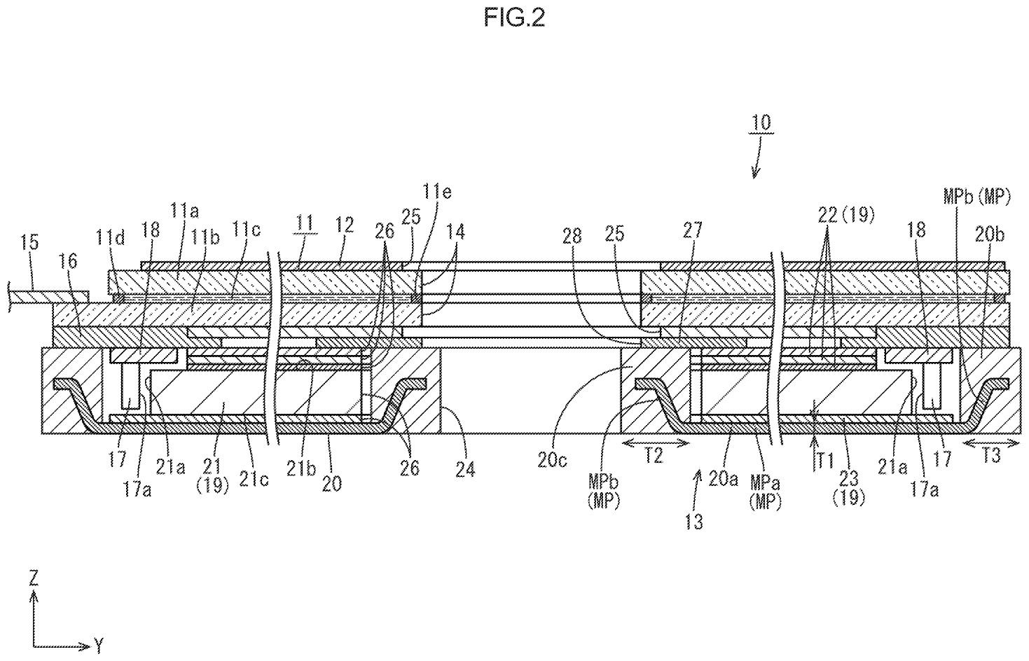

A first embodiment of the present invention will be described with reference to FIGS. 1 to 3. In the present embodiment, a liquid crystal display device (display device) 10 is taken as an example. Some of the drawings illustrate an X axis, a Y axis, and a Z axis, which indicate the directions shown in the drawings. For the vertical direction, FIG. 2 is used as a reference, and the upper side of the drawing is the front side and the lower side of the drawing is the back side.

The liquid crystal display device 10 has a substantially circular shape as a whole, and as shown in FIG. 1, includes at least: a liquid crystal panel (display panel) 11 configured to display an image; a pair of front and back polarizing plates 12 that is stuck to outer front and back surfaces of the liquid crystal panel 11; and a backlight device (lighting device) 13 that is disposed on the back side (rear side) of the liquid crystal panel 11 and supplies light for display to the liquid crystal panel 11. The liquid crystal display device 10 according to the present embodiment is preferably used for a wearable terminal (not shown) such as a smart watch, but is not necessarily limited thereto.

First, the liquid crystal panel 11 will be described. As shown in FIG. 1, the liquid crystal panel 11 has a substantially circular outer shape in a planar view, and has a panel through hole 14 formed through the center in the thickness direction (Z-axis direction). The panel through hole 14 has a circular planar shape. Accordingly, the liquid crystal panel 11 has a substantially annular shape (substantially donut shape) as a whole. Specifically, the most part of the outer shape of the liquid crystal panel 11 is arcuate (curved) in a planar view, and a portion of the outer shape is linear in a planar view. Of the outer peripheral edge of the liquid crystal panel 11, a pair of linear portions is arranged in parallel with each other at positions spaced by an angular interval of about 180° in the circumferential direction around the center of the liquid crystal panel 11. A flexible substrate 15 described later is mounted on one side. In FIG. 1, the extending direction of the linear portion at the outer peripheral end of the liquid crystal panel 11 coincides with that the X-axis direction, and the direction orthogonal to the extending direction coincide with the Y-axis direction. In FIG. 2, the thickness direction of the liquid crystal panel 11 (the polarizing plates 12, an optical member 19, and an optical member support part 20a) coincides with the Z-axis direction.

As shown in FIG. 1, the liquid crystal panel 11 has a display area AA in which an image is displayed using light emitted from the backlight device 13, and the planar shape thereof is an annular shape. The liquid crystal panel 11 includes a central non-display area (center non-display area) CNAA located at the center of the inner peripheral side of the display area AA and an outer peripheral non-display area ONAA arranged on the outer peripheral side of the display area AA. No image is displayed in the central non-display area CNAA and the outer peripheral non-display area ONAA. The central non-display area CNAA includes the panel through hole 14a and the edge of the panel through hole 14, and has a circular shape in a planar view. Therefore, in the liquid crystal panel 11, the planar shapes of the panel through hole 14 and the central non-display area CNAA are similar, thereby making excellent the appearance of an image displayed in the display area AA. The outer peripheral non-display area ONAA has a substantially annular shape in a planar view, and the planar shape of the inner peripheral end thereof is circular, whereas the planar shape of the outer peripheral end thereof is identical to the outer shape of the liquid crystal panel 11. In FIG. 1, the boundary positions between the display area AA and the central non-display area CNAA and the outer peripheral non-display area ONAA are shown by alternate long and short dash lines.

As shown in FIG. 2, the liquid crystal panel 11 includes at least: a pair of glass substrates 11a and 11b that is substantially transparent and excellent in light transmissivity; liquid crystal 11c that is sandwiched between the substrates 11a and 11b and includes liquid crystal molecules of a substance changing in optical characteristics along with application of an electric field; an outer peripheral seal portion 11d that surrounds the liquid crystal 11c and is interposed between outer peripheral ends of the pair of substrates 11a and 11b to seal the liquid crystal 11c; and an inner peripheral seal portion lie that is interposed between inner peripheral ends of the pair of substrates 11a and 11b to seal the liquid crystal 11c. The outer peripheral seal portion lid is extended in a substantially annular shape along the outer shape of the liquid crystal panel 11, and is disposed in the outer peripheral non-display area ONAA. The inner peripheral seal portion lie is extended in a substantially annular shape along the edge of the panel through hole 14, and is disposed in the central non-display area CNAA.

Of the pair of substrates 11a and 11b constituting the liquid crystal panel 11, the face side (front side) one is the CF substrate 11a, and the back side (rear side) one is the array substrate 11b. As shown in FIG. 1, in the array substrate 11b, one linear portion of the outer peripheral end is flush with the same linear portion of the CF substrate 11a, but the other linear portion protrudes outward beyond the same linear portion of the CF substrate 11a. The flexible substrate 15 is attached to the protruding portion. A driver (not shown) is mounted on the flexible substrate 15 by chip on film (COF). The driver can process various input signals supplied from a panel drive circuit board (not shown) and supply the processed signals to the liquid crystal panel 11.

The internal structure (not shown) in the display area AA of the liquid crystal panel 11 will be briefly described. However, various components described below are not shown in the drawings. On the inner surface side (the liquid crystal 11c side and the side opposing the CF substrate 11a) of the array substrate 11b, large numbers of thin film transistors (TFTs) as switching elements and pixel electrodes are arranged in a matrix (rows and columns), and a gate line and a source line are disposed in a lattice shape to surround the TFTs and the pixel electrodes. A signal related to an image is supplied to the gate line and the source line by the driver described above. The pixel electrodes disposed in a rectangular area surrounded by the gate line and the source line are made of a transparent electrode material. On the other hand, a large number of color filters are arranged on the inner surface of the CF substrate 11a at positions corresponding to the pixel electrodes. The color filters of three colors of R, G, and B are alternately arranged. A light shielding layer (black matrix) for preventing color mixture is formed between the color filters. On the surface of the color filter and the light shielding layer, counter electrodes are opposed to the pixel electrodes on the array substrate 11b. An alignment film (not shown) for aligning liquid crystal molecules contained in the liquid crystal 11c is formed on the inner surfaces of both the substrates 11a and 11b.

The thus configured liquid crystal panel 11 is fixed to the backlight device 13 by a panel fixing tape (panel fixing member) 16. The panel fixing tape 16 is made of a synthetic resin and is generally formed by applying an adhesive material on both sides of a frame-shaped base material that extends along the outer peripheral end of the liquid crystal panel 11. The base material of the panel fixing tape 16 has a light blocking property because its surface is black, so that it is possible to prevent the leakage light from the backlight device 13 from being transmitted through the outer peripheral non-display area ONAA of the liquid crystal panel 11.

Next, a configuration of the backlight device 13 will be described in detail. The backlight device 13 has a substantially circular outer shape in a planar view as shown in FIG. 1 in the same manner as the liquid crystal panel 11, and is arranged to overlap the back side (opposite to the light emission side) of the liquid crystal panel 11 as shown in FIG. 2. The backlight device 13 includes at least: a light emitting diode (LED) 17 as a light source; an LED substrate (light source substrate) 18 on which the LED 17 is mounted; an optical member 19 that exerts an optical action on the light from the LED 17 to output the light toward the liquid crystal panel 11; and a chassis (housing) 20 that accommodates the foregoing components. The optical member 19 includes at least: a light guide plate (optical member) 21 that guides the light from the LED 17; optical sheets (optical members) 22 that is stacked on the front side of the light guide plate 21; and a reflection sheet (optical member, reflection member) 23 that is stacked on the back side of the light guide plate 21. The backlight device 13 is an edge light type (side light type) in which the LEDs 17 (the LED substrates 18) are arranged at positions overlapping with at least a pair of linear portions of the outer peripheral end of the liquid crystal panel 11. The backlight device 13 emits light from the LEDs 17 toward the liquid crystal panel 11 on the front side through an opening portion of the chassis 20 while converting the light into planar light by the optical action of the optical member 19. That is, the front side opposite to the backlight device 13 is the light output side. Hereinafter, the components of the backlight device 13 will be sequentially described.

As shown in FIG. 2, the LEDs 17 is configured such that an LED chip (LED element), which is a semiconductor light emitting element, is sealed with a resin material on a substrate portion fixed to the plate surface of the LED substrate 18. The LED chips mounted on the substrate portion have one main emission wavelength, and specifically, emits blue light in a single color. On the other hand, the resin material that seals the LED chips is blended with a dispersed phosphor that emits light in a predetermined color when excited by the blue light emitted from the LED chips. The resin material generally emits white light as a whole. The LEDs 17 are of a side-emitting type in which a side surface adjacent to the surface mounted on the LED substrate 18 is a light emitting surface 17a.

As shown in FIG. 2, the LED substrate 18 has a flexible film-like (sheet-like) substrate portion (base material) made of an insulating material, and the plate surface thereof is parallel to the plate surfaces of the liquid crystal panel 11 and the optical member 19. The LEDs 17 described above are surface-mounted on the back plate surface of the LED substrate 18 (the plate surface facing the light guide plate 21), and a wiring pattern (not shown) for supplying power to the LEDs 17 is patterned. The LED substrate 18 is arranged so that a portion thereof overlaps the front side of a portion of the outer peripheral end of the light guide plate 21. The LED substrate 18 is arranged on the back side of the liquid crystal panel 11 and is fixed to the liquid crystal panel 11 with a panel fixing tape 16.

The optical member 19 has a substantially circular shape in a planar view in the same manner as the liquid crystal panel 11. As shown in FIG. 2, the optical member 19 is disposed immediately below the liquid crystal panel 11, and its plate surface is parallel to the liquid crystal panel 11. In the light guide plate 21 constituting the optical member 19, out of the outer peripheral end, end surfaces of at least a pair of linear portions are light incident surfaces (light source opposing end surfaces) 21a that are opposing to the LEDs 17 and into which the light from the LEDs 17 is entered. On the other hand, out of the pair of front and back plate surfaces of the light guide plate 21, the plate surface facing the front side (the liquid crystal panel 11 side) is a light emitting surface 21b that emits light toward the liquid crystal panel 11. On the other hand, the plate surface facing the back side of the light guide plate 21 is an opposite plate surface 21c opposite to the light emitting surface 21b. The light guide plate 21 has a function of introducing through the light incident surface 21a the light emitted from the LEDs 17 in a direction substantially along the plate surface of the optical member 19, rising the light to the optical sheet 22 side (the front side, the light emitting side) while propagating the light inside, and emitting the light from the light emitting surface 21b. The opposite plate surface 21c of the light guide plate 21 has a light reflection pattern (not shown) formed from a light reflecting portion that reflects the light in the light guide plate 21 toward the light emitting surface 21b to facilitate the emission from the light emitting surface 21b.

As shown in FIG. 2, the optical sheet 22 constituting the optical member 19 is placed on the front side of the light emitting surface 21b of the light guide plate 21, and is interposed between the liquid crystal panel 11 and the light guide plate 21. Accordingly, the optical sheet 22 transmits the light and causes the light transmitted from the light guide plate 21 to travel toward the liquid crystal panel 11 while exerting a predetermined optical action on the transmitted light. The optical sheet 22 is provided in a form in which sheets (three sheets in the present embodiment) overlap each other. There are specific types thereof such as, for example, diffusion sheet, lens sheet (prism sheet), reflective polarizing sheet, and the like. The optical sheet 22 can be appropriately selected from these types. Further, the back surface of the panel fixing tape 16 is fixed to the outer peripheral end portion of the optical sheet 22 arranged on the foremost side.

As shown in FIG. 2, the reflection sheet 23 constituting the optical member 19 covers the back side of the light guide plate 21, that is, the opposite plate surface 21c opposite to the light emitting surface 21b. The reflection sheet 23 is made of a synthetic resin sheet material having a silver surface with excellent light reflectivity. Thus, the reflection sheet 23 can effectively raise the light having been propagated through the light guide plate 21 and emitted from the opposite plate surface 21c, toward the front side (the light emitting surface 21b). The reflection sheet 23 is sandwiched between the light guide plate 21 and an optical member support part 20a of the chassis 20 described later. The outer peripheral end portion of the reflection sheet 23 extends outward beyond the outer peripheral end surface of the light guide plate 21. In particular, the end portion of the reflection sheet 23 on the LED substrate 18 side extends from the light incident surfaces 21a of the light guide plate 21 up to a position beyond the LEDs 17. Thus, the light from the LEDs 17 can be efficiently reflected by the extending portion and entered into the light incident surfaces 21a.

The chassis 20 has a substantially circular outer shape in a planar view like the liquid crystal panel 11. As shown in FIG. 2, when being formed in a substantially box shape opened to the front side as a whole, the chassis 20 is allowed to accommodate the LEDs 17, the LED substrate 18, the optical member 19, and others. The chassis 20 includes the optical member support part (bottom part) 20a that supports the optical member 19 from the back side (opposite to the liquid crystal panel 11 side), and a frame-shaped part (side part, picture frame-shaped part) 20b that rises from the outer peripheral end of the optical member support part 20a toward the front side. The optical member support part 20a has a plate surface that is parallel to the respective plate surfaces of the liquid crystal panel 11 and the optical member 19 and constitutes the optical member 19 accommodated in the chassis 20, and is arranged in a stacked manner. The optical member support part 20a supports the laminated light guide plate 21, optical sheet 22, and reflection sheet 23 from the back side. The frame-shaped part 20b surrounds the LEDs 17, the LED substrate 18, the optical member 19, and others housed in the chassis 20 from the outer peripheral side, so that the frame-shaped part 20b is frame-shaped (picture frame-shaped) with a planar shape that is substantially circular as a whole. Further, the rear surface of the panel fixing tape 16 is fixed to the rising tip of the frame-shaped part 20b.

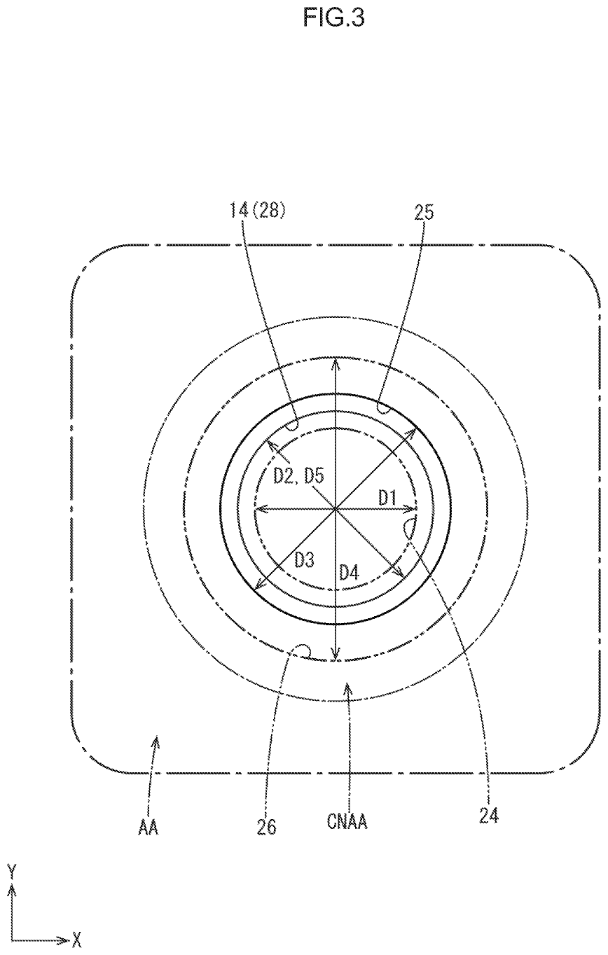

As shown in FIGS. 2 and 3, the chassis 20 according to the present embodiment has a chassis through hole (housing through hole) 24 that penetrates the chassis 20, communicates with the panel through hole 14, and is smaller than the panel through hole 14. In FIGS. 1 and 3, the chassis through hole 24 is shown by a two-dot chain line in a size slightly smaller than the panel through hole 14. As with the panel through hole 14, the chassis through hole 24 has a circular planar shape and is concentric with the panel through hole 14. The panel through hole 14 has a diameter D1 smaller than a diameter D2 of the panel through hole 14. Therefore, the entire area of the chassis through hole 24 communicates with the panel through hole 14, and the entire peripheral surface of the chassis through hole 24 projects more inward (toward the center side of the through holes 14 and 24) than the peripheral surface of the panel through hole 14. As described above, the chassis through hole 24 penetrating the chassis 20 accommodating the LEDs 17 and others communicates with the panel through hole 14 penetrating the liquid crystal panel 11 in the thickness direction, thereby making it possible to put an external object (not shown) into the panel through hole 14 and the chassis through hole 24 from the front side or the back side. When the liquid crystal display device 10 is used in a smart watch, the external object is, for example, a shaft part of an analog type hand (long hand, short hand, second hand, or the like) or a positioning projection that is provided in the case of the smart watch for positioning the liquid crystal display device 10 to be housed therein.

As shown in FIGS. 2 and 3, the diameter D1 of the chassis through hole 24 is smaller than the diameter D2 of the panel through hole 14. Accordingly, when an external object is put into the panel through hole 14 and the chassis through hole 24 communicating with each other, the object is likely to interfere with the edge of the chassis through hole 24 having the relatively small diameter D1, and is unlikely to interfere with the edge of the panel through hole 14 having the relatively large diameter D2. Therefore, the edge of the panel through hole 14 in the liquid crystal panel 11 that is made of glass and is lower in mechanical strength than the chassis 20 is less likely to become damaged by the object interference. In particular, the chassis through hole 24 preferably serves as a positioning projection for positioning an external object that is put into the panel through hole 14 and the chassis through hole 24 and brought into contact with the edge of the chassis through hole 24. This eliminates the need for a cap member as in the prior art, so that the portion around the panel through hole 14 where no image can be displayed, that is, the inner peripheral non-display area CNAA becomes narrow, and the area in which an image can be displayed, that is, the display area AA becomes wide. Furthermore, even if there is generated a portion (an inner peripheral non-light emitting area) where light from the backlight device 13 (the LEDs 17) cannot be applied toward the liquid crystal panel 11 near the chassis through hole 24, the chassis through hole 24 is made smaller than the panel through hole 14 so that the portion where the light cannot be applied near the chassis through hole 24 is unlikely to overlap the portion where an image can be displayed in the liquid crystal panel 11. As a result, display unevenness hardly occurs on the liquid crystal panel 11, and the display quality is hardly deteriorated.

As shown in FIGS. 2 and 3, the polarizing plates 12 disposed on the outer surface of the liquid crystal panel 11 have a polarizing plate through hole 25 that penetrates the polarizing plates 12 in the thickness direction. The polarizing plate through hole 25 communicates with the panel through hole 14 and the chassis through hole 24. As with the panel through hole 14 and the chassis through hole 24, the polarizing plate through hole 25 has a circular planar shape and is concentric with the panel through hole 14 and the chassis through hole 24. The polarizing plate through hole 25 has a diameter D3 larger than the diameter D2 of the panel through hole 14. Therefore, the polarizing plate through hole 25 has its peripheral surface entirely recessed outside the peripheral surface of the panel through hole 14 (on the side opposite to the center side of the through holes 14, 24, and 25). This makes it difficult to cause a situation in which the edge of the polarizing plate through hole 25 in the polarizing plate 12 protrudes into the panel through hole 14. Accordingly, when an external object is put into the panel through hole 14, the chassis through hole 24, and the polarizing plate through hole 25 that communicate with one another, the object is unlikely to interfere with the edge of the polarizing plate through hole 25. Therefore, it is possible to avoid a situation where the polarizing plate 12 is peeled off due to the interference of the object.

As shown in FIGS. 2 and 3, the optical member 19 that is accommodated in the chassis 20 and exerts an optical action on the light from the LEDs 17 has an optical member through hole 26 that penetrates the optical member 19 and communicates with the panel through hole 14, the chassis through hole 24, and the polarizing plate through hole 25. In FIGS. 1 and 3, the optical member through hole 26 is shown by a two-dot chain line in a size slightly larger than the polarizing plate through hole 25. As with the panel through hole 14, the chassis through hole 24, and the polarizing plate through hole 25, the optical member through hole 26 has a circular planar shape and is concentric with the panel through hole 14, the chassis through hole 24, and the polarizing plate through hole 25. The optical member through hole 26 has a diameter D4 larger than the diameter D1 of the chassis through hole 24. Therefore, the optical member plate through hole 26 has its peripheral surface entirely recessed outside the peripheral surface of the chassis through hole 24 (on the side opposite to the center side of the through holes 14, 24, 25, and 26).

On the other hand, as shown in FIG. 2, the chassis 20 has a cylindrical part 20c protruding from the optical member support part 20a toward the front side (the liquid crystal panel 11 side) and connected to the optical member support part 20a. The cylindrical part 20c forms the edge of the chassis through hole 24, and an inner peripheral surface thereof forms the peripheral surface of the chassis through hole 24. Therefore, the cylindrical part 20c has a cylindrical shape that is concentric with the through holes 14, 24, 25, and 26, and has an inner diameter thereof that coincides with the diameter D1 of the chassis through hole 24. The outer diameter of the cylindrical part 20c is larger than the diameters D1 to D3 of the panel through hole 14, the chassis through hole 24, and the polarizing plate through hole 25, but is smaller than the diameter D4 of the optical member through hole 26 of the optical member 19. Accordingly, when the optical member 19 is placed into the chassis 20, the cylindrical part 20c can be passed through the optical member through hole 26 of the optical member 19. As described above, the cylindrical part 20c constituting the chassis 20 forms the edge of the chassis through hole 24 and protrudes from the optical member support part 20a toward the liquid crystal panel 11. Thus, when an external object is put into the chassis through hole 24, the object can be firmly received by the cylindrical part 20c. In particular, the cylindrical part 20c preferably serves as a positioning projection for positioning an external object that is put into the chassis through hole 24 and brought into contact with the cylindrical part 20c. The cylindrical part 20c penetrates through the optical member 19 in the thickness direction, communicates with the chassis through hole 24, and passes through the optical member through hole 26 larger than the chassis through hole 24. Therefore, the cylindrical part 20c is arranged inside the edge of the optical member through hole 26 in the optical member 19. Thus, even when an external object is put into the chassis through hole 24, it is possible to prevent the object from interfering with the edge of the optical member through hole 26. That is, the optical member 19 can be protected by the cylindrical part 20c so that the optical member 19 can provide appropriate optical performance.

The configuration of the chassis 20 will be described in more detail. As shown in FIG. 2, in the chassis 20, the optical member support part 20a is made of a metal plate (sheet metal) MP, whereas the frame-shaped part 20b and the cylindrical part 20c are mainly made of a synthetic resin material. Therefore, the optical member support part 20a has a thickness T1 smaller than the thicknesses T2 and T3 of the frame-shaped part 20b and the cylindrical part 20c. The entire optical member support part 20a is made of a metal plate material MP. On the other hand, the frame-shaped part 20b and the cylindrical part 20c are made of a metal plate material MP partially extended from the optical member support part 20a, but most of the part covering the metal plate material MP is made of a synthetic resin material. Of the metal plate material MP, the part constituting the optical member support part 20a is a flat-plate-shaped part MPa having a plate surface parallel to the plate surfaces of the optical member 19 and others, whereas a part constituting some portions of the frame-shaped part 20b and the cylindrical part 20c is a bent part MPb that is bent and risen from the optical member support part 20a toward the front side. Of the frame-shaped part 20b and the cylindrical part 20c, the portion made of the synthetic resin material surrounds the entire bent part MPb of the metal plate material MP so as not to be exposed to the outside. An insert molding method is used in the production of the thus configured chassis 20. First, a flat metal plate material before molding is subjected to press molding or the like, thereby to form the flat-plate-shaped part MPa (the entire optical member support part 20a) and the bent part MPb (some portions of the frame-shaped part 20b and the cylindrical part 20c). After that, the processed metal plate material MP is inserted into a molding die for resin molding, a synthetic resin material in a molten state is injected into the molding die, and the synthetic resin material is cooled and solidified to form the frame-shaped part 20b and the cylindrical part 20c. As described above, at the time of production of the chassis 20, the frame-shaped part 20b and the cylindrical part 20c can be formed by resin molding using a molding die, so that the dimensional accuracy and positional accuracy of the frame-shaped part 20b and the chassis through hole 24 become high. Accordingly, the outer shape of the chassis 20 becomes appropriate, and an external object can be easily put into the chassis through hole 24. Moreover, since the optical member support part 20a of the chassis 20 is made of the metal plate material MP, the optical member support part 20a is thinner than in a case where the optical member support part is made of a synthetic resin material. This is suitable for reducing the thickness of the chassis 20 and the liquid crystal display device 10.

Further, as shown in FIG. 2, a fixing tape (fixing member) 27 having a light blocking property is provided near the chassis through hole 24 so as to be interposed between the liquid crystal panel 11 and the backlight device 13. The fixing tape 27 is formed by applying an adhesive material to both surfaces of a base material made of synthetic resin. The fixing tape 27 has an annular shape surrounding the panel through hole 14, the chassis through hole 24, and the polarizing plate through hole 25. The fixing tape 27 has a fixing tape through hole (fixing member through hole) 28 at the center position that penetrates the fixing tape 27 in the thickness direction and communicates with the panel through hole 14, the chassis through hole 24, the polarizing plate through hole 25, and the optical member through hole 26. The fixing tape through hole 28 has a diameter (an inner diameter of the fixing tape 27) D5 that is larger than the diameter D1 of the chassis through hole 24 and is substantially the same as the diameter D2 of the panel through hole 14. The outer diameter of the fixing tape 27 is larger than the diameter D4 of the optical member through hole 26. Accordingly, of the fixing tape 27, an adhesive material on a front side is mainly adhered to the edge of the polarizing plate through hole 25 in the polarizing plate 12 attached to the outer surface of the back side of the liquid crystal panel 11, whereas an adhesive material on a back side is adhered astride the cylindrical part 20c as the edge of the chassis through hole 24 in the chassis 20 and the edge of the optical member through hole 26 in the optical sheet 22 on the foremost side of the optical member 19. Thus, the liquid crystal panel 11 and the backlight device 13 are fixed to each other by the fixing tape 27 interposed therebetween. Since the fixing tape 27 has a light blocking property, even if light leaks from the vicinity of the chassis through hole 24 of the backlight device 13 due to the chassis 20 having the chassis through hole 24, the leaked light can be blocked by the fixing tape 27, thereby suppressing the light leakage to the liquid crystal panel 11. The fixing tape 27 has the fixing tape through hole 28 that penetrates in the thickness direction, communicates with the chassis through hole 24, and is larger than the chassis through hole 24. Thus, when an external object is input into the chassis through hole 24, the edge of the fixing tape through hole 28 is unlikely to interfere with the object.

As described above, the liquid crystal display device (display device) 10 of the present embodiment includes: the liquid crystal panel (display panel) 11 that has the panel through hole 14 penetrating in the thickness direction and displays an image; the LEDs (light source) 17 that emit light for display on the liquid crystal panel 11; and the chassis (housing) 20 that accommodates the LEDs 17 and has the chassis through hole (housing through hole) 24 penetrating the chassis 20, communicating with the panel through hole 14, and smaller than the panel through hole 14.

In this way, an image is displayed on the liquid crystal panel 11 by using the light emitted from the LEDs 17. The chassis through hole 24 penetrating the chassis 20 accommodating the LEDs 17 and others communicates with the panel through hole 14 penetrating the liquid crystal panel 11 in the thickness direction, thereby making it possible to put an external object into the panel through hole 14 and the chassis through hole 24. Since the chassis through hole 24 is smaller than the panel through hole 14, when an external object is put into the panel through hole 14 and the chassis through hole 24 as described above, the object is likely to interfere with the edge of the relatively small chassis through hole 24 and is less likely to interfere with the edge of the relatively large panel through hole 14. Therefore, the edge of the panel through hole 14 in the liquid crystal panel 11 generally lower in mechanical strength than the chassis 20 is unlikely to suffer from damage or the like. In particular, this is suitable to, for example, a case of putting an object for positioning the liquid crystal display device 10 in the panel through hole 14 and the chassis through hole 24. This eliminates the need for a cap member as in the prior art, so that the portion around the panel through hole 14 where no image can be displayed becomes narrow, thereby widening an area in which an image can be displayed. Furthermore, even if there is generated a portion where light from the LEDs 17 cannot be applied toward the liquid crystal panel 11 near the chassis through hole 24, the chassis through hole 24 is made smaller than the panel through hole 14 so that the portion where the light cannot be applied near the chassis through hole 24 is unlikely to overlap the portion where an image can be displayed in the liquid crystal panel 11. As a result, display unevenness hardly occurs on the liquid crystal panel 11, and the display quality is hardly deteriorated.

The liquid crystal display device 10 includes the polarizing plates 12 that are disposed on the outer surface of the liquid crystal panel 11 and have the polarizing plate through hole 25 penetrating in the thickness direction, communicating with the panel through hole 14, and larger than the panel through hole 14. In this way, the polarizing plate through hole 25 penetrating the polarizing plate 12 on the outer surface of the liquid crystal panel 11 in the thickness direction communicates with the panel through hole 14 and the chassis through hole 24. Setting the polarizing plate through hole 25 to be larger than the panel through hole 14 makes it difficult to cause a situation in which the edge of the polarizing plate through hole 25 protrudes into the panel through hole 14. Accordingly, when an external object is put into the panel through hole 14, the chassis through hole 24, and the polarizing plate through hole 25, the object is unlikely to interfere with the edge of the polarizing plate through hole 25, and the polarizing plate 12 is less likely to peel off.

The liquid crystal display device 10 further includes the optical member 19 that is accommodated in the chassis 20 and exerts an optical action on the light from the LEDs 17, and has the optical member through hole 26 penetrating in the thickness direction, communicating with the chassis through hole 24, and larger than the chassis through hole 24. The chassis 20 includes at least the optical member support part 20a that supports the optical member 19 from the side opposite to the liquid crystal panel 11 side and the cylindrical part 20c that constitutes the edge of the chassis through hole 24, protrudes from the optical member support part 20a toward the liquid crystal panel 11, and connects to the optical member support part 20a. In this way, the light emitted from the LEDs 17 is subjected to the optical action by the optical member 19 and then emitted to the liquid crystal panel 11. The optical member 19 is supported from the side opposite to the liquid crystal panel 11 side by the optical member support part 20a constituting the chassis 20, so that the optical member 19 can exhibit the optical performance appropriately. The cylindrical part 20c constituting the chassis 20 forms the edge of the chassis through hole 24 and protrudes from the optical member support part 20a toward the liquid crystal panel 11. Thus, when an external object is put into the chassis through hole 24, the object can be firmly received by the cylindrical part 20c. The cylindrical part 20c penetrates through the optical member 19 in the thickness direction, communicates with the chassis through hole 24, and passes through the optical member through hole 26 larger than the chassis through hole 24. Therefore, the cylindrical part 20c is arranged inside the edge of the optical member through hole 26 in the optical member 19. Thus, even when an external object is put into the chassis through hole 24, it is possible to prevent the object from interfering with the edge of the optical member through hole 26. That is, the optical member 19 can be protected by the cylindrical part 20c.

The chassis 20 has the cylindrical part 20c made of a synthetic resin material. Thus, at the time of production of the chassis 20, the cylindrical part 20c can be formed by resin molding using a molding die, so that the dimensional accuracy and positional accuracy of the chassis through hole 24 become high. Thereby, it becomes easy to put an external object into the chassis through hole 24.

In the chassis 20, the optical member support part 20a is made of the metal plate material MP. In this way, the optical member support part 20a is made thinner than in a case where the optical member support part is made of a synthetic resin material. This is suitable for reducing the thickness of the chassis 20 and the liquid crystal display device 10.

The chassis 20 also has the frame-shaped part 20b made of a synthetic resin material that is connected to the outer end portion of the optical member support part 20a. In this way, the frame-shaped part 20b connected to the outer end portion of the optical member support part 20a constituting the chassis 20 is made of a synthetic resin material, which makes it possible to form the frame-shaped part 20b by resin molding using a molding die at the time of production of the chassis 20. Accordingly, the dimensional accuracy and positional accuracy related to the frame-shaped part 20b become high, and the outer shape of the chassis 20 becomes appropriate.

Further, the liquid crystal display device 10 includes: the backlight device (lighting device) 13 that is formed from at least the LEDs 17 and the chassis 20 to apply light for display to the liquid crystal panel 11; and the fixing tape 27 (fixing member) that is interposed between the liquid crystal panel 11 and the backlight device 13, has a light blocking property, and has the fixing tape through hole (fixing member through hole) 28 penetrating in the thickness direction, communicating with the chassis through hole 24, and larger than the chassis through hole 24. Thus, the liquid crystal panel 11 and the backlight device 13 are fixed to each other by the fixing tape 27 interposed therebetween. Since the fixing tape 27 has a light blocking property, even if light leaks from the vicinity of the chassis through hole 24 of the backlight device 13 due to the chassis 20 having the chassis through hole 24, the leaked light can be blocked by the fixing tape 27, thereby suppressing the light leakage to the liquid crystal panel 11. The fixing tape 27 has the fixing tape through hole 28 that penetrates in the thickness direction, communicates with the chassis through hole 24, and is larger than the chassis through hole 24. Thus, when an external object is input into the chassis through hole 24, the edge of the fixing tape through hole 28 is unlikely to interfere with the object.

### Second Embodiment

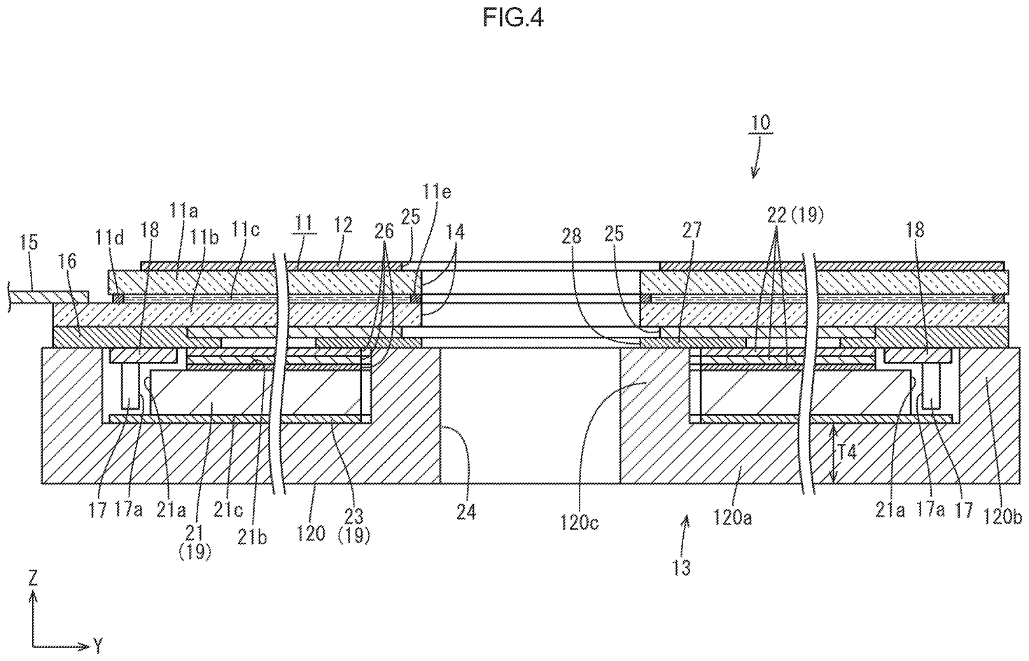

A second embodiment will be described with reference to FIG. 4. In the second embodiment, a chassis 120 is taken in a modified configuration. Redundant descriptions of the same structures, operations, and effects as those of the first embodiment will be omitted.

As shown in FIG. 4, in the chassis 120 according to the present embodiment, an optical member support part 120a, a frame-shaped part 120b, and a cylindrical part 120c are entirely made of a synthetic resin material. In this configuration, a thickness T4 of the optical member support part 120a is larger than the thickness T1 of the optical member support part 20a of the first embodiment described above. However, since the frame-shaped part 120b and the cylindrical part 120c are made of a synthetic resin material, it is possible to not only obtain the operations and effects equivalent to those of the first embodiment but also preferably reduce the production cost of the chassis 120 because there is no need for insert molding using a metal plate material as in the first embodiment.

### Third Embodiment

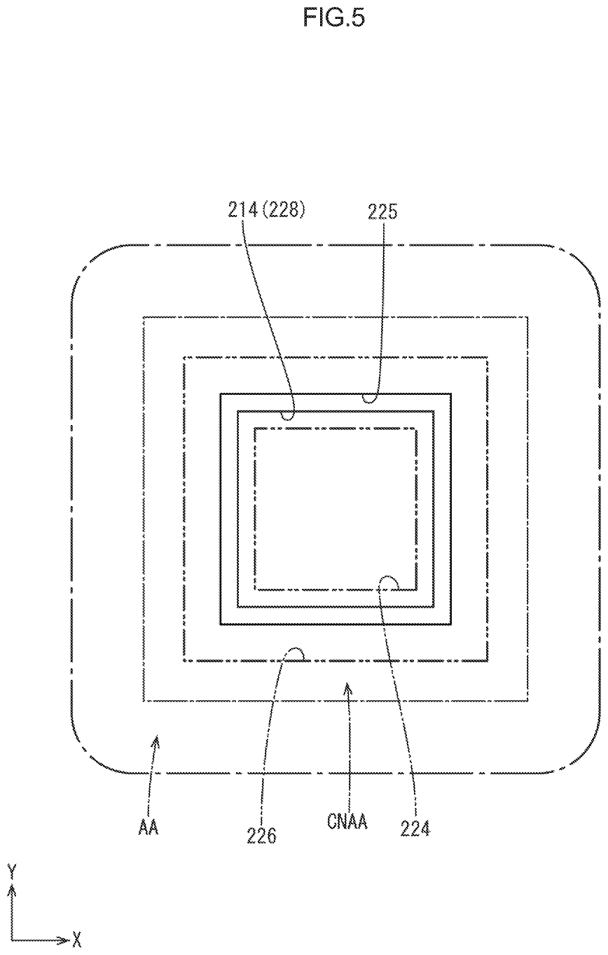

A third embodiment will be described with reference to FIG. 5. In the third embodiment, through holes 214, 224, 225, 226, and 228 are taken in planar shapes different from those in the first embodiment. Redundant descriptions of the same structures, operations, and effects as those of the first embodiment will be omitted.

As shown in FIG. 5, the panel through hole 214, the chassis through hole 224, the polarizing plate through hole 225, the optical member through hole 226, and the fixing tape through hole 228 according to the present embodiment are square in shape. Even with this configuration, the same operations and effects as those of the first embodiment can be obtained.

### Other Embodiments

The present invention is not limited to the embodiments described above and illustrated in the drawings. For example, the following embodiments also fall within the technical scope of the present invention:

(1) In the above-described embodiments, the planar shapes of through holes are a circle or square. However, the planar shapes of the through holes are not limited to a circle or square but may be an ellipse, semicircle, rectangle, triangle or trapezoid.

(2) Unlike the above-described embodiments, the entire chassis can be made of a metal plate.

(3) In the above-described embodiments, the diameter of the polarizing plate through hole is smaller than the diameter of the panel through hole. However, the diameter of the polarizing plate through hole is may be almost the same as the diameter of the panel through hole.

(4) In the above-described embodiments, the diameter of the optical member through hole is the largest among the diameters of the through holes. However, the diameter of the optical member through hole may be almost the same as the diameter of the polarizing plate through hole and the diameter of the panel through hole, for example.

(5) In the above-described embodiments, the diameter of the fixing tape through hole is almost the same as the diameter of the panel through hole. However, the diameter of the fixing tape through hole may be smaller than the diameter of the panel through hole or the diameter of the polarizing plate through hole. Alternatively, the diameter of the fixing tape through hole may be larger than the diameter of the panel through hole.

(6) In the above-described embodiments, all the planar shapes of the through holes are the same. However, some of the through holes may have a different planar shape.

(7) In the above-described embodiments, the chassis has a cylindrical part. However, the chassis may have no cylindrical part. In this case, the chassis through hole penetrates the optical member support part, and the optical member support part has the edge of the chassis through hole. It is also possible to remove the frame-shaped part from the chassis.

(8) In the above-described embodiments, the LEDs are arranged to face the end surfaces of at least a pair of linear portions of the outer peripheral end portion of the light guide plate. However, the LEDs may be arranged to face, of the end portion, only the end surface of the linear portion overlapping the flexible substrate, for example. In addition, the specific layout and number of LEDs can be changed as appropriate.

(9) In the above-described embodiments, the outer shape viewed from the plane of the liquid crystal display device is substantially circular. However, the outer shape viewed from the plane of the liquid crystal display device may be square, rectangular, trapezoidal, semicircular, or oval.

(10) In the above-described embodiments, the LEDs are exemplified as the light source. However, organic ELs or the like may be used as the light source.

(11) In the above-described embodiments, the liquid crystal display device is used for a wearable terminal such as a smart watch. However, the intended use of the liquid crystal display device can be appropriately changed.

### EXPLANATION OF SYMBOLS

10: Liquid crystal display device (Display device)
11: Liquid crystal panel (Display panel)
12: Polarizing plate
13: Backlight device (Lighting device)
14, 214: Panel through hole
17: LED (Light source)
19: Optical member
20, 120: Chassis (Housing)
20a, 120a: Optical member support part
20b, 120b: Frame-shaped part
20c, 120c: Cylindrical part
24, 224: Chassis through hole (Housing through hole)
25, 225: Polarizing plate through hole
26, 226: Optical member through hole
27: Fixing tape (Fixing member)
28, 228: Fixing tape through hole (Fixing member through hole)
MP: Metal plate material

1. A display device comprising:
a display panel that has a panel through hole penetrating in a thickness direction and displays an image;
a light source that emits light for display on the display panel; and
a housing that accommodates the light source and has a housing through hole penetrating the housing, communicating with the panel through hole, and smaller than the panel through hole.

2. The display device according to claim 1, comprising an polarizing plate that is disposed on an outer surface of the display panel and has a polarizing plate through hole penetrating in the thickness direction, communicating with the panel through hole, and larger than the panel through hole.

3. The display device according to claim 1, comprising an optical member that is accommodated in the housing, exerts an optical action on the light from the light source, and has an optical member through hole penetrating in the thick direction, communicating with the housing through hole, and larger than the housing through hole, wherein
the housing has at least: an optical member support part that supports the optical member from a side opposite to a display panel side; and a cylindrical part that constitutes an edge of the housing through hole, protrudes from the optical member support part toward the display panel, and connects to the optical member support part.

4. The display device according to claim 3, wherein, in the housing, the cylindrical part is made of a synthetic resin material.

5. The display device according to claim 3, wherein, in the housing, the optical member support part is made of a metal plate material.

6. The display device according to claim 3 wherein the housing includes a frame-shaped part that connects to an outer end portion of the optical member support part and is made of a synthetic resin material.

7. The display device according to claim 1, comprising:
a lighting device that is formed from at least the light source and the housing to apply the light for display to the display panel; and
a fixing member that is interposed between the display panel and the lighting device, has a lighting blocking property, and has a fixing member through hole penetrating in the thickness direction, communicating with the housing through hole, and larger than the housing through hole.
